(19) United States
(12) Patent Application Publication
(10) Pub. No.: US 2019/0188739 A1
(43) Pub. Date: Jun. 20, 2019

(54) DETERMINING A STATISTIC ABOUT RESOURCES EXPENDED FOR GOODS OR SERVICES IN A CONTEXT

(71) Applicant: Google Inc., Mountain View, CA (US)

(72) Inventors: Amay Nitin Champaneria, San Francisco, CA (US); Frederick Peter Brewin, San Francisco, CA (US)

(21) Appl. No.: 14/322,537

(22) Filed: Jul. 2, 2014

(51) Int. Cl. G06Q 30/02

(52) U.S. Cl. CPC G06Q 30/0202

(57) ABSTRACT

Methods, apparatus and computer-readable media (transitory and non-transitory) are disclosed for identifying a good or service of potential interest to the user and a context in which the good or service would be consumed, determining, based on historical data, a statistic about resources expended by other users to consume goods or services of a same class as the good or service of potential interest to the user in contexts that correspond to the predicted context, and providing an indication of the statistic. In some implementations, the good or service of potential interest to the user may be predicted, e.g., based on one or more signals associated with the user.

### BACKGROUND

There may be costs, currency conventions and/or spending standards specific to a location or region of which a traveler may not be aware. As an example, a traveler may not have a sense of what a taxi from an airport to a hotel should cost, and is therefore at the mercy of a taxi driver who may or may not be scrupulous. As another example, a traveler may not be aware of specific tipping practices in a region she is visiting, and could consequently over or under tip. In addition to monetary costs, travelers may be unaware of other types of resources, such as time, that may be required to consume a particular good or service in a particular context.

### SUMMARY

This specification is directed generally to methods and apparatus for determining statistics about resources (e.g., money, time) expended by a plurality of users for goods or services in various contexts. Those statistics may be provided, for instance, to a user who is interested in, or is predicted to be potentially interested in, consuming a particular good or service in a particular context.

In some implementations, a computer implemented method may be provided that includes the steps of: detecting one or more signals associated with a user; predicting, based on the one or more signals, a good or service of potential interest to the user and a context in which the good or service would be consumed; determining, based on historical data, a statistic about resources expended by other users to consume goods or services of a same class as the good or service of potential interest to the user in contexts that correspond to the predicted context; and providing an indication of the statistic.

In some implementations, a computer implemented method may be provided that includes the steps of: determining, based on one or more signals associated with a user, a context associated with the user; identifying a good or service of interest to the user; determining, based on contextual data passively collected from a plurality of users, a statistic about resources expended by other users to consume goods or services of a same class as the good or service of interest to the user, wherein contexts associated with the other users correspond to the context associated with the user; and providing an indication of the statistic.

These methods and other implementations of technology disclosed herein may each optionally include one or more of the following features.

In various implementations, historical data may include receipts of past purchases associated with a plurality of users. In various implementations, a predicted good or service of potential interest to the user may be transportation between a first location and a second location. Determining a statistic may include determining an expected fare or travel time associated with the transportation. In various implementations, the transportation includes a taxi ride between the first location and the second location. In various implementations, historical data may include one or more taxi fares paid by one or more other users that travelled between the first location and the second location.

In various implementations, a predicted context may include a predicted time of day or predicted time of year in which the user will be consuming the predicted good or service of potential interest to the user. In various implementations, determining the statistic may include determining resources expended by other users to consume the goods or services of the same class within a predetermined time interval of the predicted time of day or predicted time of year.

In various implementations, the predicted good or service of potential interest to the user may be a visit to a particular location of interest. Determining the statistic may include determining an expected time the user will spend at the location of interest. In various implementations, the one or more detected signals may include a position coordinate obtained from a mobile computing device associated with the user. In various implementations, predicting the good or service of potential interest to the user may be based at least in part on past behavior or preferences of the user.

Other implementations may include a non-transitory computer readable storage medium storing instructions executable by a processor to perform a method such as one or more of the methods described above. Yet another implementation may include a system including memory and one or more processors operable to execute instructions, stored in the memory, to perform a method such as one or more of the methods described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an example environment in which statistics about resource expenditure for goods or services in various contexts may be determined and/or provided.

FIG. 2 illustrates an example interface that may rendered for a user depicting expected resource expenditures for various goods or services.

FIG. 3 is a flow chart illustrating an example method of determining statistics about expected resource expenditure for goods or services in various contexts.

FIG. 4 illustrates an example architecture of a computer system.

### DETAILED DESCRIPTION

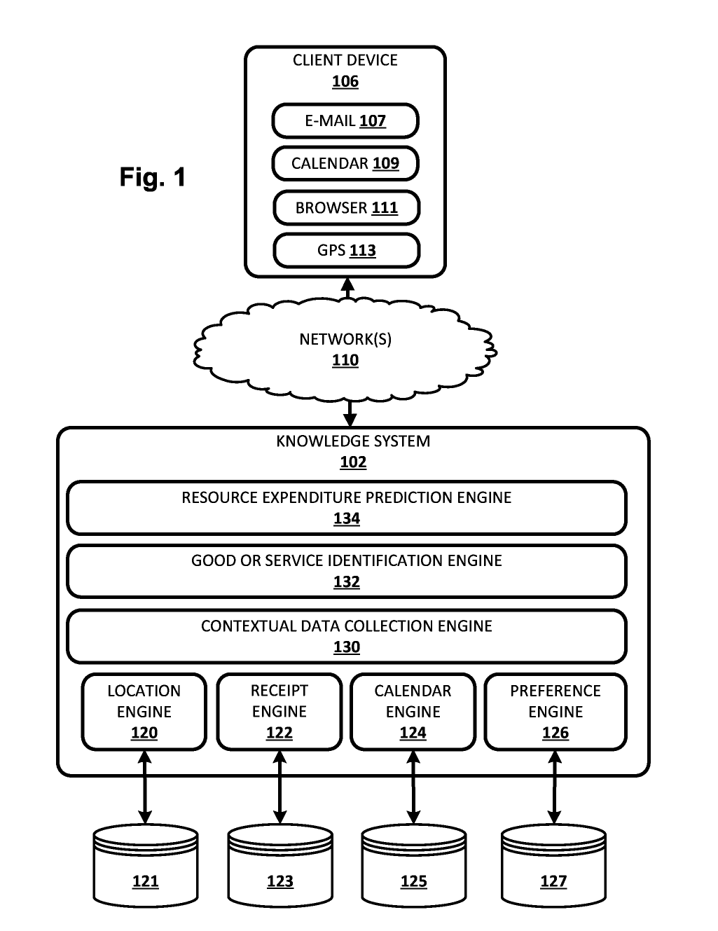

FIG. 1 illustrates an example environment in which statistics about expected resource expenditure for goods or services in various contexts may be determined and/or provided. The example environment includes a client device 106 and a knowledge system 102. Knowledge system 102 may be implemented in one or more computers that communicate, for example, through a network (not depicted). Knowledge system 102 is an example of an information retrieval system in which the systems, components, and techniques described herein may be implemented and/or with which systems, components, and techniques described herein may interface.

A user may interact with knowledge system 102 via client device 106 and/or other computing systems (not shown). Client device 106 may be a computer coupled to the knowledge system 102 through one or more networks 110 such as a local area network (LAN) or wide area network (WAN) such as the Internet. The client device 106 may be, for example, a desktop computing device, a laptop computing device, a tablet computing device, a mobile phone computing device, a computing device of a vehicle of the user (e.g., an in-vehicle communications system, an in-vehicle entertainment system, an in-vehicle navigation system), or a wearable apparatus of the user that includes a computing device (e.g., a watch of the user having a computing device, glasses of the user having a computing device). Additional and/or alternative client devices may be provided. While the user likely will operate a plurality of computing devices, for the sake of brevity, examples described in this disclosure will focus on the user operating client device 106.

Client device 106 may operate one or more applications and/or components which may facilitate user consumption of goods or services, as well as provide various types of signals about the user. These application and/or components may include but are not limited to an email client 107, a calendar component 109 (which in some implementations may be a client, in others may be standalone, and in some cases may be integrated with email client 107), a browser 111, and so forth. In some implementations, browser 111 may be used as a de facto email and/or calendar client. In some instances, one or more of these applications and/or components may be operated on multiple client devices operated by the user.

Client device 106 and knowledge system 102 each include one or more memories for storage of data and software applications, one or more processors for accessing data and executing applications, and other components that facilitate communication over a network. The operations performed by client device 106 and/or knowledge system 102 may be distributed across multiple computer systems. Knowledge system 102 may be implemented as, for example, computer programs running on one or more computers in one or more locations that are coupled to each other through a network.

In various implementations, knowledge system 102 may include a location engine 120, a receipt engine 122, a calendar engine 124, preference engine 126, a contextual data collection engine 130, a good or service identification engine 132, and/or resource expenditure prediction engine 134. In some implementations one or more of engines 120, 122, 124, 126, 130, 132, and/or 134 may be omitted. In some implementations all or aspects of one or more of engines 120, 122, 124, 126, 130, 132, and/or 134 may be combined. In some implementations, one or more of engines 120, 122, 124, 126, 130, 132, and/or 134 may be implemented in a component that is separate from knowledge system 102. In some implementations, one or more of engines 120, 122, 124, 126, 130, 132, and/or 134, or any operative portion thereof, may be implemented in a component that is executed by client device 106.

Location engine 120 may maintain an index 121 of records of locations (e.g., position coordinates) at which users have been detected, and/or records of locations between which users have travelled. This data may be obtained, for instance, from position coordinate devices on clients devices such as client device 106, such as global positioning system (“GPS”) component 113. In various implementations, this location data may be anonymous, so that the location records are not linkable with particular users. In various implementations, position coordinates may be obtained using technologies other than GPS, such as triangulation (e.g., using one or more cell towers). In some implementations, the location records may be linkable with other records, such as user receipts.

Receipt engine 122 may maintain an index 123 of records of purchases users have made in the past (i.e. “receipts” or “user receipts”). In various implementations, these receipts may be associated with users as opposed to vendors. For example, rather than a hotel maintaining and providing records of bookings and prices paid for its rooms, receipt engine 122 may maintain in index 123 individual user receipt records that identify the hotel as a vender. As was the case with location engine 120, receipt engine 122 may maintain this receipt data anonymously, so that receipts are not linkable with particular users.

Calendar engine 124 may be configured to maintain an index 125 of calendar entries and other scheduling-related information (e.g., tasks, reminders) associated with one or more users. In some implementations, calendar engine 124 may operate as a server, with calendar component 109 on client device acting as a client, although this is not required. For instance, users may operate and/or interact with calendar engine 124 using other mechanisms, such as browser 111. While depicted as part of knowledge system 102 in FIG. 1, in various implementations, all or part of calendar engine 124, and/or index 125, may be implemented elsewhere, e.g., on client device 106. Additionally, the engines depicted in FIG. 1 are not meant to be exhaustive. Other engines not depicted in FIG. 1, such as an instant messaging engine or voicemail engine, may also be operated in cooperation with selected aspects of the present disclosure.

Preference engine 126 may maintain an index 127 of user preferences. These user preferences may be provided by preference engine 126 to other components for various purposes. For example, potential interest in a good or service may be predicted based at least in part on data provided by preference engine 126. As another example, a user's context (e.g., at the time the user is predicted to consume a good or service) may be determined based at least on part on user preference data provided by preference engine 126.

In this specification, the term “database” and “index” will be used broadly to refer to any collection of data. The data of the database and/or the index does not need to be structured in any particular way and it can be stored on storage devices in one or more geographic locations. Thus, for example, the indices 121, 123, 125, and/or 127 may include multiple collections of data, each of which may be organized and accessed differently.

In various implementations, contextual data collection engine 130 may be configured to collect historical data about resources expended by a plurality of users for a plurality of goods or services. In some implementations, contextual data collection engine 130 may be configured to passively collect contextual data from or about a plurality of users, particularly as that data relates to consumption of goods or services by the plurality of users. To “passively” collect means that the users need not necessarily volunteer their contextual data, or even be aware that their contextual data is being collected. However, in various implementations, the contextual data passively collected may be anonymous, meaning it cannot be later associated with the user from which it was collected.

For instance, contextual data collection engine 130 may collect position coordinate data from computing devices such as client device 106 operated by a plurality of users, such as smart phones, tablets, laptops, or wearable computing devices, e.g., for storage by location engine 120 in index 121. Contextual data collection engine 130 may at the same time collect data indicative of purchases made by users, also referred to as “receipts,” for storage by receipt engine 122 in index 123. Those multiple pieces of data together and/or in combination with additional information, may define the user's “context” at a particular moment. Pieces of data stored by separate engines, such as location engine 120, receipt engine 122, or calendar engine 124, may be linkable to each other via one or more indications or annotations provided by contextual data collection engine 130, so that they together define a user's context.

In other implementations, contextual data collection engine 130 may collect historical data in other manners, such as from contractors sent out to collect data manually (e.g., by taking sample taxi rides or purchasing goods in various locations at various prices), or by crowdsourcing users to provide data voluntarily.

Good or service identification engine 132 may be configured to identify a particular good or service that a user is interested in consuming, either immediately or at some future time. In some implementations, good or service identification engine 132 may determine that a user is interested in a good or service based on direct evidence of user interest, such as deliberate activity by the user (e.g., using browser 111 to search, “What should I pay for a taxi ride from Heathrow Airport to Buckingham Palace?”). In other implementations, good or service identification engine 132 may predict a user's potential interest in a good or service based on one or more inferences drawn from one or more signals associated with a user. For instance, good or service identification engine 132 may predict, based on a user's purchase of an airline ticket to Florence and the user's booking a hotel room in Florence, that the user may have potential interest in a taxi ride (or bus ride, or train ride, or bike rental, etc.) from the Florence airport to that hotel. In some implementations, good or service identification engine 132 may additionally or alternatively identify, e.g., based on the one or more signals associated with the user, a context in which the good or service would be consumed. Continuing with the same example, good or service identification engine 132 may determine that the user would be travelling from the airport to the hotel during rush hour or during a popular cultural event in Florence such as a sporting match or festival, which may impact a taxi fare the user should expect to pay.

Resource expenditure prediction engine 134 may be configured to examine historical data, e.g., collected by contextual data collection engine 130 and/or stored in the various indices 121, 123, 125, 127, to determine resources expended by other users to consume a good or service of a same class as that predicted by good or service identification engine 132 to be of interest or potential interest to a user. Based on this examination, resource expenditure prediction engine 134 may determine one or more statistics about resources expended by other users in the same or similar contexts as the user, and may, for instance, provide an indication of that user.

Goods or services described herein are typically fungible goods or services. Resources required to consume these goods or services may be variable depending on various factors. A cost of a taxi fare may be increased during rush hour or during festivals or sporting events. A beer may be more expensive during certain evening hours that it would be earlier, e.g., during “happy hour.” Accordingly, goods and services may be described herein in terms of their “class.” A class of a good or service is its type. For instance, two users may both consume a beverage, but they would not consume the same beverage; rather, they might consume the same class of beverage (e.g., “beer,” “lager,” “pilsner,” “microbrew,” etc.).

Classes may have a variety of scopes. In some cases, classes may be very specific. For instance, a particular brand of beer that is widely sold (and thus exhibits robust historical data) may constitute a class. Resources expended for the same brand of beer may be examined to determine an expected price to pay for that beer. On the other hand, where there is less historical data available on resources expended on a particular good or service, broader classes of goods or services may be analyzed to determine an expected cost. For instance, some microbrews may have relatively small markets, but may sell for prices that are generally similar to other similarly-situated microbrews. In such case, an expected cost of a particular brand of microbrew may be determined based on resources expended on “microbrews” generally, rather than only on that particular microbrew brand.

Suppose good or service identification engine 132 predicts, based on purchase of a plane ticket to Florence on a particular day and a hotel booked in downtown Florence that evening, that a user, Sally, will potentially be interested in transportation from the Florence airport to the hotel. Suppose also that good or service identification engine 132 determines what Sally's context will be when she travels from the airport to the hotel, e.g., that it will be during rush hour. Good or service identification engine 132 may additionally determine, e.g., based on data provided by preference engine 126, that Sally prefers to travel by taxi. Based on these pieces of data, resource expenditure prediction engine 134 may identify records in various indices (e.g., 121, 123, 125, 127) collected from users in corresponding contexts, e.g., other users who prefer taxis that travelled from the Florence airport to a location at or near the hotel. Based on those identified records, resource expenditure prediction engine 134 may determine a reasonable price (or range of prices) the user should expect to pay for a taxi ride from the Florence airport to the hotel.

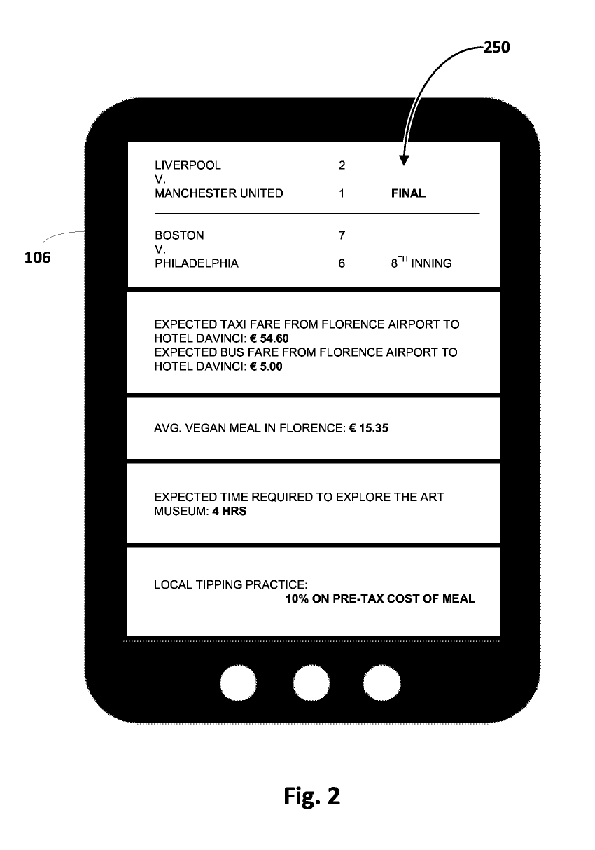

FIG. 2 schematically depicts an example interface 250 that may be rendered by client device 106 to Sally, e.g., after purchasing a plane ticket to Florence and booking a hotel, and/or after landing in Florence. Client device 106 is depicted in this example as a smart phone or tablet computer, but that is not meant to be limiting. As noted above, client device 106 may come in various other forms. In this example, interface 250 includes various graphical portions, or “cards,” that depict various types of information that may be of interest to Sally. These cars may be selectively rendered to Sally based on a variety of signals associated with Sally. For instance, the top card includes scores of sporting events in which Sally may be interested, for instance.

The second card down includes expected fares from the Florence airport to the hotel using various modes of transportation. Because Sally prefers taxis (e.g., as indicated by preference engine 126), the taxi fare (€54.60) is listed first, and the bus fare (€5.00) is listed second. In some embodiments, if the user's preference for taxis is strong enough, other fares may not be presented at all.

The third card down depicts an expected cost (€15.35) for a vegan meal in Florence. This card may be presented to Sally as a consequence of, for instance, good or service identification engine 132 predicting that Sally will be interested in eating a vegan meal, e.g., based on user preference data provided by preference engine 126 or based on past behavior by Sally (e.g., frequent purchase of vegan food) that is evidenced by data provided by receipt engine 122. The expected cost of €15.35 may be determined, e.g., by resource expenditure prediction engine 134, based on resources expended by other users with corresponding contexts (e.g., visiting Florence, preference for vegan) for a good of a corresponding class (e.g., vegan dining out).

The fourth card down in FIG. 2 depicts another example of expected resource expenditure, this time in temporal terms. An amount of time that Sally should expect to spend in order to fully explore a local museum is depicted. In some implementations, this information may be determined, e.g., by resource expenditure prediction engine 134, based on contextual data collected, e.g., by contextual data collection engine 130, from mobile computing devices operated by other users who visited the museum. For example, position coordinates may be obtained at ingress and egress of mobile computing devices (e.g., client device 106) from the museum, and the time intervals in between may be used, e.g., by resource expenditure prediction engine 134, to determine an amount of time to expect to spend in the museum. In some embodiments, resource expenditure prediction engine 134 may take into account other signals or factors when making this determination, such as mobility of the user (e.g., if the user is wheelchair bound, only times spent by other wheelchair-bound visitors will be used), age of the user, and so forth.

The fifth card down in FIG. 2 depicts another example of expected resource expenditure, local tipping practice. Here, resource expenditure prediction engine 134 may determine expected tipping percentages in a particular area by analyzing receipts, e.g., provided by receipt engine 122, for meals purchased in Florence and perhaps in the surrounding areas or even all of Italy. In some implementations, Sally may configure her preferences, e.g., by interacting with preference engine 126, so that only receipts for meals purchased by tourists in Italy, rather than receipts all meals purchased by anyone in Italy (tourists or locals), are examined, e.g., so that Sally will know what is expected of tourists.

Goods or services, and expected resource expenditures associated with them, are not limited to those discussed above and shown in FIG. 2. Expected resource expenditures for other goods or services are also contemplated herein. These include but are not limited to an expected cost (temporal or monetary) of a particular excursion (e.g., golf, kayak or bike tour, etc.), customary price of a gift (e.g., to be given at a wedding, a birthday party, a baptism, and so forth), expected cost for medical care, expected cost (temporal or monetary) for a wellness service (e.g., massage, facial, yoga instruction, etc.), expected cost (e.g., tip expected) for bellhop service, and so forth. In some embodiments, even a type of resource expected to be expended or accepted at a particular establishment, such as a type of currency expected or accepted or a type of credit card accepted, may be determined by resource expenditure prediction engine 134.

Expected expenditures for goods or services may be based on data other than historical data about past expenditure of resources for goods or services. For example, factors such as general cost of living in an area or even gross domestic product (GDP) may be taken into account. As another example, rules or regulations relating to costs may also be taken into account. For example, in some cities, taxis are governed by various regulations that dictate how the calculate a fare. In some instances, particular taxi rides (e.g., from one airport to another) may have fixed fees.

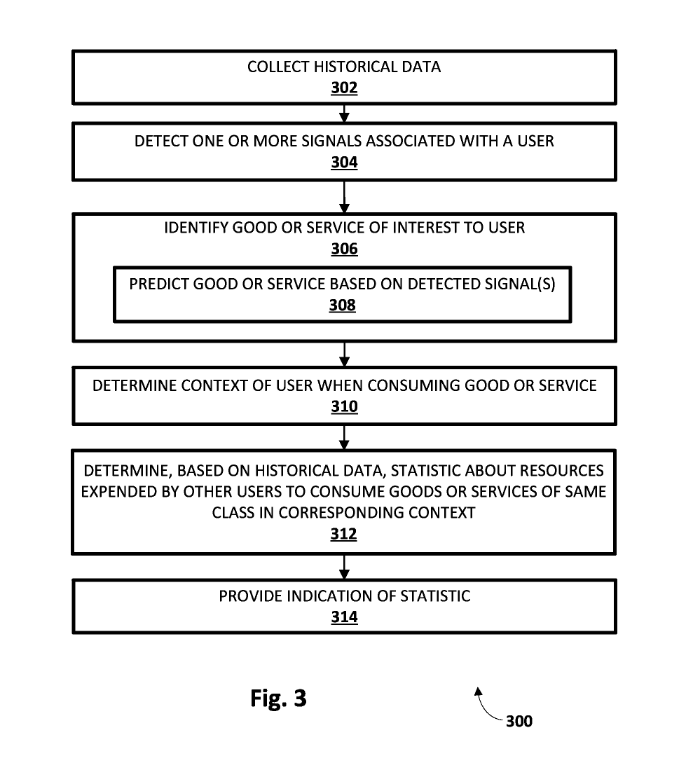

FIG. 3 schematically depicts an example method 300 of determining statistics about resource expenditure for goods or services in various contexts. For convenience, the operations of the flow chart are described with reference to a system that performs the operations. This system may include various components of various computer systems. For instance, some operations may be performed at the client device 106, while other operations may be performed by one or more components of the knowledge system 102, such as location engine 120, receipt engine 122, calendar engine 124, preference engine 126, contextual data collection engine 130, good or service identification engine 132, resource expenditure prediction engine 134, and so forth. Moreover, while operations of method 300 are shown in a particular order, this is not meant to be limiting. One or more operations may be reordered, omitted or added.

At block 302, the system may collect historical data about resources expended by a plurality of users for various goods or services in various contexts. For example, contextual data collection engine 130 may passively collect contextual data from a plurality of computing devices (e.g., smart phones, smart glasses, smart watches, vehicle navigation systems, etc.) that often accompany users when travelling. Contextual data collection engine 130 may additionally or alternatively collect data related to purchases made by the plurality of users. The purchase data may be linked to other contextual data, so that contexts of users may be associated with expected resource expenditures for various goods or services in those contexts.

In some instances, block 302 may additionally or alternatively include collection of data by one or more contractors or employees sent out into the field to gather data. In some instances, block 302 may include collection of data using crowdsourcing. Although shown as a first block in method 300, the operation of block 302 may occur continuously and/or in parallel to other operations described herein. In some instances, resource expenditure data for a good or service in a particular location (or in another context) may be lacking. In such case, the system may extrapolate resource expenditure data for that region from other-similarly situated regions, e.g., nearby or of similar socio-economic status.

At block 304, the system may detect one or more signals associated with a user. These signals may be detected well ahead the time at which a good or service may be consumed by a user (e.g., signals such as purchase of an airline ticket and booking of a hotel room), or immediately prior (e.g., upon landing at an airport). Signals associated with a user may include but are not limited to communications (e.g., emails, texts, instant messages, social network posts, etc.) sent to or by a user, position coordinates of a user (e.g., obtained by GPS component 113), purchases (i.e., receipts) associated with a user, calendar entries created by or for a user, and so forth.

At block 306, the system may identify one or more goods or services of potential interest to the user. In some implementations, e.g., at block 308, the system may predict these goods or service of potential interest to the user based on the one or more signals detected at block 304. As described in the example above, purchase of a light to a particular city and booking of a hotel room in that city on the date of arrival may cause the system to predict that the user will be interested in a service-transportation from the airport to the hotel. In other implementations, the system may identify the good or service of potential interest to the user in a more straight-forward manner, e.g., in direct response to a user's search engine query.

At block 310, the system may determine a context of the user when the user would be consuming the good or service identified at block 306. This context may be determined, for instance, based on one or more of the signals detected at block 304. For example, continuing the ongoing example, suppose Sally's airline ticket indicates she'll land in Florence at 5 pm. The system may determine that Sally's context while travelling from the airport to the hotel will be travelling on road during rush hour. This likely would increase an expected amount of time required to make the trip, and likely would increase the expected taxi fare as well.

At block 312, the system may determine, based on the historical data collected at block 302, the good or service identified at block 306, and/or the context determined at block 310, one or more statistics about resources expended by other users to consume goods or services of a same class as that identified at block 306, in a context that corresponds to that determined at block 310. In some implementations, determining the statistic may include determining resources expended by other users to consume the goods or services of the same class within a predetermined time interval of a predicted time of day or predicted time of year at which a good will be consumed. For instance, determining what Sally will pay for the taxi from the Florence airport to her hotel during rush hour may include analyzing taxi fares paid by other users travelling similar routes at or near rush hour.

At block 314, the system may provide an indication of the statistic. For example, in some implementations, the system may generate an itinerary for a traveler. The system may include in the itinerary annotations that indicate what particular aspects of the trip should cost. For instance, there may be an expected cost (monetary and/or temporal) shown for transportation between two points of interest, an expected cost of admission, a generally accepted tipping practice or generally accepted currency in a particular region, and so forth. As another example that may be used in real time, the system may provide the user with notification, e.g., that pops up on her smart phone or that appears as a “card” in an application (e.g., as depicted in FIG. 2), which the user may heed or ignore.

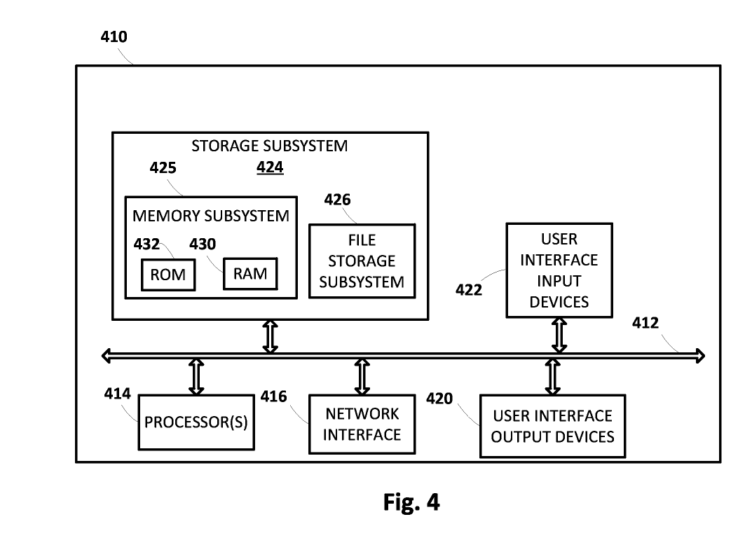

FIG. 4 is a block diagram of an example computer system 410. Computer system 410 typically includes at least one processor 414 which communicates with a number of peripheral devices via bus subsystem 412. These peripheral devices may include a storage subsystem 424, including, for example, a memory subsystem 425 and a file storage subsystem 426, user interface output devices 420, user interface input devices 422, and a network interface subsystem 416. The input and output devices allow user interaction with computer system 410. Network interface subsystem 416 provides an interface to outside networks and is coupled to corresponding interface devices in other computer systems.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 410 to the user or to another machine or computer system.

Storage subsystem 424 stores programming and data constructs that provide the functionality of some or all of the modules described herein. For example, the storage subsystem 424 may include the logic to perform selected aspects of method 300, as well as one or more of the operations performed by location engine 120, receipt engine 122, calendar engine 124, preference engine 126, contextual data collection engine 130, good or service identification engine 132, resource expenditure prediction engine 134, and so forth.

These software modules are generally executed by processor 414 alone or in combination with other processors. Memory 425 used in the storage subsystem can include a number of memories including a main random access memory (RAM) 430 for storage of instructions and data during program execution and a read only memory (ROM) 432 in which fixed instructions are stored. A file storage subsystem 426 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computer system 410 communicate with each other as intended. Although bus subsystem 412 is shown schematically as a single bus, alternative implementations of the bus subsystem may use multiple busses.

Computer system 410 can be of varying types including a workstation, server, computing cluster, blade server, server farm, or any other data processing system or computing device. Due to the ever-changing nature of computers and networks, the description of computer system 410 depicted in FIG. 4 is intended only as a specific example for purposes of illustrating some implementations. Many other configurations of computer system 410 are possible having more or fewer components than the computer system depicted in FIG. 4.

In situations in which the systems described herein collect personal information about users, or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A computer-implemented method, comprising:
detecting a position coordinate generated by a position coordinate sensor of a mobile device carried by a user;
predicting, based at least in part on the position coordinate location, a good or service of potential interest to the user, wherein the predicted good or service of potential interest to the user is a visit to a single geographic location of interest associated with the position coordinate;
predicting a context in which the good or service will be consumed based on a time at which the position coordinate was detected;
determining, based on historical data contained in a location index, a first statistic about time spent by other users at the single geographic location in contexts that correspond to the predicted context, wherein the historical data in the location index comprises a plurality of position coordinates obtained from a plurality of mobile computing devices, and the first statistic about time spent by other users at the single geographic location comprises an expected time the user will spend at the single geographic location of interest;
determining, based on historical data contained in a receipts index, a second statistic about money spent by other users at the single geographic location in contexts that correspond to the predicted context, wherein the historical data in the receipts index comprises data indicative of a plurality of receipts and corresponding position coordinates at which the receipts were generated, and the second statistic about money spent by other users at the single geographic location comprises an expected amount of money the user will spend at the single geographic location of interest; and
in response to the detecting and predicting, causing the mobile computing device operated by the user to render, on a touch screen, one or more cards, wherein the one or more cards include a visual indication of the first statistic and a visual indication of the second statistic.

2-5. (canceled)

6. The computer-implemented method of claim 1, wherein the predicted context includes a predicted time of day or predicted time of year in which the user will be consuming the predicted good or service of potential interest to the user.

7. The computer-implemented method of claim 6, wherein determining the first and second statistics comprises determining resources expended by other users to consume the goods or services of the same class within a predetermined time interval of the predicted time of day or predicted time of year.

8-9. (canceled)

10. The computer-implemented method of claim 1, wherein predicting the good or service of potential interest to the user is further based at least in part on past behavior or preferences of the user.

11. A system including memory and one or more processors operable to execute instructions stored in the memory, comprising instructions to:
determine, based on a position coordinate generated by one or more mobile computing devices carried by a user and a time at which the position coordinate was obtained, a context associated with the user;
identify, based on the determined context, a good or service of interest to the user, wherein the predicted good or service of potential interest to the user is a visit to a single geographic location of interest;
determine, based on contextual data passively collected from a plurality of users, a first statistic about a first type of resource expended by other users to consume goods or services of a same class as the good or service of interest to the user, wherein contexts associated with the other users correspond to the context associated with the user, wherein the contextual data comprises a plurality of position coordinates obtained from a plurality of mobile computing devices carried by the plurality of users;
determine, based on the contextual data passively collected from the plurality of users, a second statistic about a second type of resource expended by other users to consume goods or services of a same class as the good or service of interest to the user, wherein contexts associated with the other users correspond to the context associated with the user; and
causing one or more of the mobile computing devices operated by the user to render, on a touch screen, one or more graphical elements, wherein the one or more graphical elements include a visual indication of the first statistic and a visual indication of the second statistic.

12. The system of claim 11, wherein the contextual data includes receipts of past purchases associated with the plurality of users.

13-15. (canceled)

16. The system of claim 11, wherein the context associated with the user includes a predicted time of day or predicted time of year in which the user will be consuming the predicted good or service of interest to the user.

17. The system of claim 16, wherein the first and second statistics comprise resources expended by other users to consume the goods or services of the same class within a predetermined time interval of the predicted time of day or predicted time of year.

18-20. (canceled)

21. The method of claim 1, wherein the plurality of position coordinates obtained from the plurality of mobile computing devices were obtained at respective ingresses to and egresses from the single geographic location by the plurality of mobile computing devices.

22. The system of claim 11, wherein of the plurality of position coordinates obtained from the plurality of mobile computing devices were obtained at respective ingresses to and egresses from the single geographic location by the plurality of mobile computing devices.

23. The at least one non-transitory computer-readable medium of claim 24, wherein of the plurality of position coordinates obtained from the plurality of mobile computing devices were obtained at respective ingresses to and egresses from the single geographic location by the plurality of mobile computing devices.

24. A non-transitory computer-readable medium comprising instructions that, in response to execution of the instructions by one or more computing devices, cause the one or more computing devices to perform the following operations:
detecting a position coordinate generated by a position coordinate sensor of a mobile device carried by a user;
predicting, based at least in part on the position coordinate location, a good or service of potential interest to the user, wherein the predicted good or service of potential interest to the user is a visit to a single geographic location of interest associated with the position coordinate;
predicting a context in which the good or service will be consumed based on a time at which the position coordinate was detected;
determining, based on historical data contained in a location index, a first statistic about time spent by other users at the single geographic location in contexts that correspond to the predicted context, wherein the historical data in the location index comprises a plurality of position coordinates obtained from a plurality of mobile computing devices, and the first statistic about time spent by other users at the single geographic location comprises an expected time the user will spend at the single geographic location of interest;
determining, based on historical data contained in a receipts index, a second statistic about money spent by other users at the specific location in contexts that correspond to the predicted context, wherein the historical data in the receipts index comprises data indicative of a plurality of receipts and corresponding position coordinates at which the receipts were generated, and the second statistic about money spent by other users at the specific location comprises an expected amount of money the user will spend at the single geographic location of interest; and
in response to the detecting and predicting, causing the mobile computing device operated by the user to render, on a touch screen, one or more cards, wherein the one or more cards include a visual indication of the first statistic and a visual indication of the second statistic.
